(19) United States
(12) Patent Application Publication
(10) Pub. No.: US 2026/0270942 A1
(43) Pub. Date: Sep. 10, 2026

(54) LIGHTWEIGHT INTELLIGENT LOCALIZATION METHOD FOR MULTI-BASE-STATION INTEGRATED SENSING AND COMMUNICATIONS (ISAC)

(71) Applicant: University of Electronic Science and Technology of China, Chengdu (CN)

(72) Inventors: Haozhe ZHANG, Chengdu (CN); Ze Chen, Chengdu (CN); Ping Yang, Chengdu (CN); Jianping Wei, Chengdu (CN); Yiyang Fu, Chengdu (CN)

(73) Assignee: University of Electronic Science and Technology of China, Chengdu (CN)

(21) Appl. No.: 19/366,591

(22) Filed: Oct. 23, 2025

(30) Foreign Application Priority Data
Mar. 6, 2025 (CN) 202510259611.6

(51) Int. Cl. H04W 64/00; H04B 17/309; H04W 84/06

(52) U.S. Cl. CPC H04W 64/00; H04B 17/346; H04W 84/06

(57) ABSTRACT

A lightweight intelligent localization method for multi-base-station integrated sensing and communications (ISAC) is provided. To improve stability and accuracy of a multi-base-station system in localizing an unmanned aerial vehicle (UAV), the present disclosure proposes a two-stage screening neural network architecture on a basis that a plurality of base stations estimate coordinates of the UAV by using a least squares subspace rotational invariance technique. This architecture uses a dynamic threshold grouping mechanism in a first stage to realize differentiable base station pre-screening through a straight-through estimator (STE); and in a second stage, designs a learnable exponential correction term that combines physical characteristics of a distance and a signal-to-noise ratio (SNR), and constructs a multi-objective loss function to simultaneously optimize localization accuracy and physical consistency. While maintaining a lightweight characteristic, this solution supports millisecond-level real-time localization on an embedded device, significantly improving navigation reliability of the UAV in a complex electromagnetic environment.

### CROSS REFERENCE TO THE RELATED APPLICATIONS

This application is based upon and claims priority to Chinese Patent Application No. 202510259611.6, filed on Mar. 6, 2025, the entire contents of which are incorporated herein by reference.

### TECHNICAL FIELD

The present disclosure relates to the technical field of integrated sensing and communications (ISAC) in wireless communications, and specifically, to a lightweight intelligent localization method for multi-base-station ISAC.

### BACKGROUND

As the most important carrier in low-altitude economy, an unmanned aerial vehicle (UAV) has advantages such as flexible maneuverability, low cost, high precision, and strong environmental adaptability. The UAV is technically unmanned and intelligent, which significantly improves operational efficiency and safety, reshaping traditional industrial forms and opening up new application scenarios.

The integrated sensing and communications (ISAC) technology can simultaneously utilize a communication signal and environmental sensing information to extract target feature information, and more accurately identify a type, a status, and a position of the UAV, thereby localizing, tracking, and identifying the UAV with high precision. Through fusion of multi-dimensional sensing data, the UAV can reduce its own weight, increase a range, and complete a task more autonomously.

The application of the ISAC technology in a low-altitude environment requires fast response and accurate localization to assist the UAV in target tracking and real-time obstacle avoidance. Among current mainstream localization algorithms, a single base station system realizes localization by using direction of arrival (DOA) estimation and other algorithms. The single base station system has a relatively simple system structure, which imposes a low requirement for time synchronization but results in a relatively large localization error. A traditional multi-base-station localization system can achieve higher-precision localization by using a time difference of arrival (TDOA) estimation algorithm, performing multi-level fusion on estimation results of a plurality of base stations, and other methods. However, these methods have insufficient adaptability and stability in practical applications, making it difficult to identify and eliminate incorrect localization information, which may lead to a sharp increase in localization errors and fail to meet practical needs.

Compared with traditional methods, multi-base-station collaborative sensing assisted by artificial intelligence (AI) can be more flexibly applied in complex practical scenarios. A reason is that through deep learning and other technologies, the system can extract richer features from an ISAC signal, thereby improving accuracy and reliability of target detection. In addition, an AI algorithm can more accurately identify and distinguish a real target, an interfering target, or an erroneous signal, thereby reducing a probability of a false alarm and a missed detection. Due to a limited input dimension of multi-base-station symbol-level fusion, a lightweight neural network model can be well applied to this scenario. As a basic neural network model, a multilayer perceptron (MLP) has a small quantity of parameters and low computational complexity, and can quickly complete data inference. In the case of a small input data dimension, the MLP can effectively learn a feature in input data and make a prediction. Compared with a complex deep learning model, the MLP achieves shorter inference time, and can meet a requirement of millisecond-level real-time processing. However, performance of a single MLP largely depends on selection of an initial weight, and different initial values may lead to different results. Moreover, a problem such as gradient vanishing or gradient explosion may occur in a training process, affecting convergence of the model.

### SUMMARY

An objective of the present disclosure is to propose a lightweight intelligent localization method for multi-base-station ISAC to address the aforementioned limitations, so as to enhance stability and accuracy of a multi-base-station system in localizing a UAV. While maintaining a lightweight feature, this solution reduces localization errors in an urban canyon scenario, improves accuracy of identifying an abnormal base station, and enhances reliability of localizing and tracking the UAV in a complex electromagnetic environment.

A technical solution of the present disclosure is as follows: A two-stage screening method combining a lightweight perceptron and an attention mechanism is used to integrate estimation results of a plurality of base stations to complete localization. As shown in FIG. 1, an ISAC localization system includes a UAV and N ISAC base stations. Each of the N ISAC base stations independently transmits a signal based on an orthogonal frequency division multiplexing (OFDM) waveform as an ISAC signal, and receives a corresponding echo signal from the UAV, and positions of the N ISAC base stations are known. The localization method includes:

S1. estimating a pitch angle and an azimuth angle of the UAV based on echo signals received by the N ISAC base stations from the UAV, and obtaining coordinates of the UAV, specifically:
defining an expression of a μ^{th} symbol on an m^{th} subcarrier of an echo signal received by an n^{th} ISAC base station from the UAV as follows:

$${C}_{n} ( m , μ ) = {U}_{n} {e}^{- j 4 π m Δ {fR}_{n} / c} + η ( m , μ )$$

where Rₙ represents a distance of the UAV in a direction of the n^{th} ISAC base station, Uₙ represents an amplitude attenuation, Δƒ represents a subcarrier spacing, c represents a speed of light, η represents noise, and noise follows a Gaussian distribution with a mean of 0 and a variance of σ², and (m, μ) represents the μ^{th} symbol on the m^{th} subcarrier;
setting that each of the N ISAC base stations is equipped with an X-Y axis L-shaped antenna array with an antenna spacing being half a wavelength and a quantity of antennas on each axis being M, defining θₙ and φₙ to respectively represent an included angle between a signal incidence direction of the UAV and an X-axis of the n^{th} ISAC base station and an included angle between the signal incidence direction of the UAV and a Z-axis of the n^{th} ISAC base station, and dividing antennas on the X-axis of the n^{th} ISAC base station into two parallel subarrays, where a first subarray X₁ contains the 1^{st} to the M-1th antennas, and a second subarray X₂ contains the 2^{nd} to the M^{th} antennas; and a steering vector of the X-axis of the n th ISAC base station is as follows:

$${a}_{x , n} = {[ 1 , {e}^{- j π cos {θ}_{n} sin {φ}_{n}} , … , {e}^{- j π ( {M}_{x} - 2 ) cos {θ}_{n} sin {φ}_{n}} ]}^{T}$$

respectively representing echo signals received by the X₁ and the X₂ as follows:

$${R}_{x 1 , r , n} = {a}_{x , n} {s}_{r , n} + {N}_{x 1 , r , n}$$

$${R}_{x 2 , r , n} = {a}_{x , n} {Φ}_{x , n} {s}_{r , n} + {N}_{x 2 , r , n}$$

where Φ_{x,n}=exp(−πa cos θₙ sin φₙ), s_{r,n} represents an r^{th} row of a received signal Cₙ, and N_{x1,r,n} and N_{x2,r,n} respectively represent additive white Gaussian noise on the subarrays X₁ and X₂;
obtaining the Φ_{x,n} by using a least squares subspace rotational invariance algorithm based on the R_{x1,r,n} and the R_{x2,r,n},
similarly, extracting Φ_{y,n}=exp(−jπ sin θₙ sin φₙ) from a signal received by a Y-axis antenna;
combining the Φ_{x,n} and the Φ_{y,n}, and obtaining an estimated azimuth angle \tilde{θ}ₙ and an estimated pitch angle \tilde{φ}ₙ;
where a steering vector of the n^{th} ISAC base station in a distance dimension is as follows:

$${a}_{d , n} = {( 1 {e}^{- j 2 πΔ f \frac{2 {R}_{n}}{c}} … {e}^{- j 2 π ( {N}_{c} - 1 ) Δ f \frac{2 {R}_{n}}{c}} )}^{T}$$

where d represents the distance dimension, and No represents a quantity of subcarriers of a signal;
respectively representing echo signals of the X₁ and the X₂ in the distance dimension as follows:

$${R}_{x 1 , d , r , n} = {a}_{d , n} {s}_{r , n} + {N}_{x 1 , d , r , n}$$

$${R}_{x 2 , d , r , n} = {a}_{d , n} {Φ}_{d , n} {s}_{r , n} + {N}_{x 2 , d , r , n}$$

where Φ_{d,n}=exp(−jπΔf2Rₙ/c), and N_{x1,d,r,n} and N_{x2,d,r,n} respectively represent additive white Gaussian noise of the subarrays X₁ and X₂ in the distance dimension;
substituting the R_{x1,d,r,n} and the R_{x2,d,r,n} into the least squares subspace rotational invariance algorithm, obtaining Φ_{x,n}, and further calculating an estimated distance \tilde{R}ₙ of the UAV relative to each of the N ISAC base stations based on the Φ_{x,n}; and
estimating relative coordinates of the UAV based on the parameters \tilde{θ}ₙ, \tilde{φ}ₙ, and \tilde{R}ₙ, where because an absolute position of each of the N ISAC base stations is known, each of the N ISAC base stations calculates a group of absolute coordinates of the UAV, which is denoted as (\tilde{x}ₙ, \tilde{y}ₙ, \tilde{z}ₙ); and estimating a signal-to-noise ratio (SNR) SNR of a channel between each of the NISAC base stations and the UAV;
S2. generating training data by using a method in the S1, specifically: randomly generating an intermediate obstacle between the UAV and each of the N ISAC base stations, combining parameters generated by each of the N ISAC base stations according to the method in the S1 to form a vector (\tilde{x}ₙ, \tilde{y}ₙ, \tilde{z}ₙ, \tilde{R}ₙ, SNRₙ), synthesizing vectors of the N ISAC base stations into an N×5-dimensional vector as an input of a neural network, recording real coordinates that are of the UAV and correspond to each group of vectors as a label, and generating a plurality of groups of input vectors of the neural network to constitute the training data;
S3. constructing an integrated localization network, where the integrated localization network includes a data input module, a base station group screening module, an intra-group fine-grained weighting module, and a coordinate output module; and a data processing process of the integrated localization network is as follows: after the data input module standardizes coordinate components (\tilde{x}ₙ, \tilde{y}ₙ, \tilde{z}ₙ) of the input N×5-dimensional vector by using a normal distribution and normalizes the estimated distance \tilde{R}ₙ through logarithmic transformation, converting a parameter vector of the n^{th} ISAC base station into

$${v}_{n} = ( {\tilde{x}}_{n}^{′} , {\tilde{y}}_{n}^{′} , {\tilde{z}}_{n}^{′} , {\tilde{R}}_{n}^{′} , {SNR}_{n} ) ;$$

inputting normalized data into the base station group screening module, where in the base station group screening module, a first fully connected layer obtains a feature projection hₙ=ReLU(W₁vₙ+b₁) by using a rectified linear unit (ReLU) activation function, where L represents a dimension of a fully connected layer, W represents an L×5-dimensional weight matrix, and b represents an L-dimensional bias vector; a second connected layer performs quality scoring to obtain a score sₙ=W₂vₙ+b₂∈□ corresponding to the n^{th} ISAC base station, where W₂ represents a 1×L₁-dimensional weight matrix, and b₂ represents a one-dimensional bias vector; and then adaptively selecting a threshold, comparing a gradient of the sₙ with the threshold by using a straight-through estimator (STE), dynamically generating a 0/1 binary mask, and assigning 0 to an ISAC base station whose sₙ is less than the threshold to eliminate an obviously abnormal ISAC base station, so as to initially select a base station group formed by N′ normal ISAC base stations; and
performing, by the intra-group fine-grained weighting module, physically-guided fine-grained integration on the selected base station group, where since a localization error of each of the N ISAC base stations is positively correlated with the estimated distance and negatively correlated with the SNRₙ a coding layer that combines coordinate coding and physical coding is adopted, where a coordinate coding layer extracts a spatial feature

$${c}_{n} = {W}_{4} ( ReLU ( {W}_{3} ( {\tilde{x}}_{n}^{′} , {\tilde{y}}_{n}^{′} , {\tilde{z}}_{n}^{′} ) + {b}_{3} ) ) of coordinates ( {\tilde{x}}_{n}^{′} , {\tilde{y}}_{n}^{′} , {\tilde{z}}_{n}^{′} ) ,$$

where W₃ represents an L₃×3-dimensional weight matrix, W₄ represents an L₄×L₃-dimensional weight matrix, and b₃ represents an L₃-dimensional bias vector; and a physical coding layer extracts a physical quantity feature

$${p}_{n} = ( {\tilde{R}}_{n}^{′} , {SNR}_{n} ) ;$$

concatenating the features of the two coding layers to obtain a joint feature fₙ=[cₙ; pₙ], inputting the fₙ into an attention generation layer to obtain a base weight αₙ, introducing a learnable exponential correction term SNR^{β}^{₁}/R^{β}^{₂} to strengthen a physical law constraint, and obtaining a final weight

$${α}_{n}^{′}$$

of the n^{th} ISAC base station after performing normalization processing on a mask constraint; and obtaining integrated localization coordinates

$$( \hat{x} , \hat{y} , \hat{z} ) = {\sum }_{n = 1}^{{N}^{′}} {α}_{n}^{′} ( {\tilde{x}}_{n}^{′} , {\tilde{y}}_{n}^{′} , {\tilde{z}}_{n}^{′} )$$

based on the weight

$${α}_{n}^{′}$$

and estimated values (\tilde{x}ₙ, \tilde{y}ₙ, \tilde{z}ₙ) of each of the NISAC base stations; and
S4. training, based on the training data obtained in the S2, the integrated localization network constructed in the S3, and obtaining a trained integrated localization network; and
S5. inputting a group of newly obtained data (\tilde{x}ₙ, \tilde{y}ₙ, \tilde{z}ₙ, \tilde{R}ₙ, SNRₙ) into the trained integrated localization network, and obtaining a localization result.

The present disclosure achieves the following beneficial effects: While maintaining a lightweight characteristic, the present disclosure supports a millisecond-level real-time localization on an embedded device, significantly improving navigation reliability of the UAV in a complex electromagnetic environment.

### BRIEF DESCRIPTION OF THE DRAWINGS

FIG. 1 is a schematic diagram of an ISAC system model according to the present disclosure; and
FIG. 2 is a schematic diagram of a two-stage cascaded neural network architecture according to the present disclosure.

### DETAILED DESCRIPTION OF THE EMBODIMENTS

The present disclosure uses a two-stage screening method combining a lightweight perceptron and an attention mechanism to integrate estimation results of a plurality of base stations to complete localization. As shown in FIG. 1, an ISAC localization system includes a UAV and N ISAC base stations. Each of the N ISAC base stations independently transmits a signal based on an orthogonal frequency division multiplexing waveform (OFDM) as an ISAC signal, and receives a corresponding echo signal from the UAV to estimate coordinates of the UAV. The estimated coordinates, a distance, and an SNR are input into a lightweight neural network for training.

The present disclosure includes the following steps:

S1. A channel waveform model is constructed by dividing a received signal matrix point by a transmitted signal matrix. An expression for a response of a μ^{th} symbol on an m^{th} subcarrier of an n^{th} carrier of an OFDM echo is as follows:

$${C}_{n} ( m , μ ) = {U}_{n} {e}^{- j 4 π m Δ {fR}_{n} / c} + η ( m , μ ) \qquad ( Formula 1 )$$

where Rₙ represents a distance of the UAV in a direction of an n^{th} ISAC base station, Uₙ represents an amplitude attenuation, Δf represents a subcarrier spacing, c represents a speed of light, η represents noise, and noise follows a Gaussian distribution with a mean of 0 and a variance of σ², and (m, μ) represents the μ^{th} symbol on the m^{th} subcarrier.

A pitch angle and an azimuth angle are estimated. Each of the N ISAC base stations is equipped with an X-Y axis L-shaped antenna array with an antenna spacing being half a wavelength and a quantity of antennas on each axis being M. θₙ and φₙ respectively represent an included angle between an incidence direction and an X-axis of the n^{th} ISAC base station and an included angle between the incidence direction and a Z-axis of the n^{th} ISAC base station. If the UAV is above the N ISAC base stations, a value range of the pitch angle φₙ is (0, π/2), and a value range of the azimuth angle θₙ is (−π, π). Antennas on the X-axis of the n^{th} ISAC base station are divided into two parallel subarrays: subarray X₁ contains the 1^{st} to the M-1^{th} antennas, and subarray X₂ contains the 2^{nd} to the M^{th} antennas. Therefore, an X-axis steering vector of the n^{th} ISAC base station is as follows:

$${a}_{x , n} = {[ 1 , {e}^{- j π cos {θ}_{n} sin {φ}_{n}} , … , {e}^{- j π ( {M}_{x} - 2 ) cos {θ}_{n} sin {φ}_{n}} ]}^{T} . \qquad ( Formula 2 )$$

Echo signals received by the subarray X₁ and the subarray X₂ are as follows:

$${R}_{x 1 , r , n} = {a}_{x , n} {s}_{r , n} + {N}_{x 1 , r , n} , \qquad ( Formula 3 )$$

$${R}_{x 2 , r , n} = {a}_{x , n} {Φ}_{x , n} {s}_{r , n} + {N}_{x 2 , r , n} , \qquad ( Formula 4 )$$

where Φ_{x,n}=exp(−πa cos θₙ sin φₙ), s_{r,n} represents an r^{th} row of a received signal Cₙ, and N_{x1,r,n} and N_{x2,r,n} respectively represent additive white Gaussian noise on the subarrays X₁ and X₂. Similarly, echo signals received by two subarrays Y₁ and Y₂ on a Y-axis can be obtained. Similarly, a steering vector of the n^{th} ISAC base station in a distance dimension is as follows:

$${a}_{d , n} = {( \begin{matrix}1 & {e}^{- j 2 πΔ f \frac{2 {R}_{n}}{c}} & ⋯ & {e}^{- j 2 π ( {N}_{c} - 1 ) Δ f \frac{2 {R}_{n}}{c}}\end{matrix} )}^{T} \qquad ( Formula 5 )$$

The two subarrays on the X-axis can obtain echo signals in the distance dimension. Distance \tilde{R}ₙ, azimuth angle \tilde{θ}ₙ, and pitch angle \tilde{φ}ₙ of the UAV relative to each of the N ISAC base stations can be obtained by using a least squares subspace rotational invariance technique (namely, Total-Least-Squares Estimating Signal Parameters via Rotational Invariance Technique (TLS-ESPRIT)). Relative coordinates of the UAV can be obtained based on these parameters. Because an absolute position of each of the N ISAC base stations is known, each of the N ISAC base stations can calculate a group of absolute coordinates of the UAV, which is denoted as (\tilde{x}ₙ, \tilde{y}ₙ, \tilde{z}ₙ). In addition, SNR SNRₙ of a channel between each of the N ISAC base stations and the UAV is estimated.

S2. 0 to 2 intermediate obstacles are randomly generated, causing coordinates estimated by each of the N ISAC base stations for the UAV to be randomly incorrect. Each of the N ISAC base stations generates vector (\tilde{x}ₙ, \tilde{y}ₙ, \tilde{z}ₙ, \tilde{R}ₙ, SNRₙ). Estimated vectors of the N ISAC base stations are synthesized into an N×5-dimensional vector as an input of a neural network. Real coordinates that are of the UAV and correspond to each group of vectors are recorded to provide a label. The S2 is repeatedly performed to generate a sufficient amount of training data.

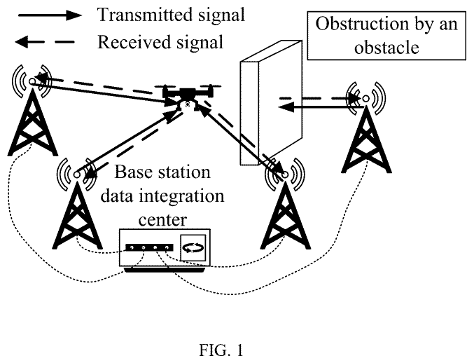

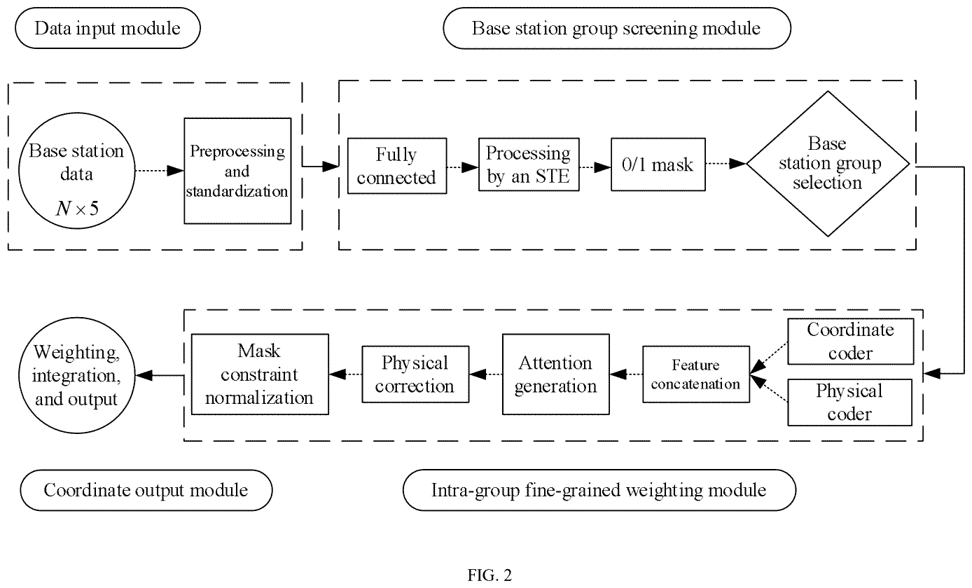

S3. A two-stage cascaded neural network architecture is constructed. As shown in FIG. 2, the network structure in the present disclosure can be divided into a data input module, a base station group screening module, an intra-group fine-grained weighting module, and a coordinate output module. The data input module performs normalization preprocessing on the input N×5-dimensional vector, standardizes coordinate components (\tilde{x}ₙ, \tilde{y}ₙ, \tilde{z}ₙ) by using a normal distribution, and normalizes the distance \tilde{R}ₙ through logarithmic transformation. The base station group screening module, as a first stage, uses a lightweight perceptron network and a dynamic threshold to quickly filter out an obviously abnormal ISAC base station. After coordinate, distance, and SNR features of each of the N ISAC base stations are input, a lightweight fully connected layer generates an initial quality score and adaptively selects a threshold. A straight-through estimator (STE) is used to dynamically generate a 0/1 binary mask, and a base station group can be initially selected quickly through a differentiable hard screening mechanism, to eliminate the obviously abnormal ISAC base station (such as a node with a too low SNR or extremely poor geometric consistency). From practical experience, it can be known that in general, a localization error of each of the N ISAC base stations is positively correlated with the estimated distance and negatively correlated with the SNR. Therefore, the intra-group fine-grained weighting module, as a second stage, needs to perform physically-guided fine-grained integration for an effective base station group: A hybrid coding layer is designed, and a coordinate space feature (a geometric relationship of MLP coding) and a physical quantity feature (a joint feature of the distance and the SNR) are separately extracted. After the features of the two coding layers are concatenated, a base weight is calculated through an attention generation layer, learnable exponential correction term SNR^{β}^{₁}/R^{β}^{₂} is introduced to strengthen a physical law constraint, and finally, a weight of the abnormal ISAC base station is forced to be zero after normalization processing is performed on a mask constraint. The coordinate output module outputs a final weight.

S4. The generated training data is input into the neural network. Parameters of each network layer are adjusted based on a magnitude of a mean square error for coordinate verification to obtain an optimal model.

S5. A group of newly obtained data (\tilde{x}ₙ, \tilde{y}ₙ, \tilde{z}ₙ, \tilde{R}ₙ, SNRₙ) is input into a trained integrated localization network, and a localization result is obtained.

The ISAC system model as shown in FIG. 1 is adopted, and simulation parameters are set as follows: A carrier frequency of OFDM is set to 24 GHz, a frequency spacing is set to 240 KHz, a quantity of carriers is set to 128, a quantity of symbols is set to 256, a planar antenna array is set to 4×4, a quantity of ISAC base stations is set to N=4, an SNR range of the channel is set to (−10, 20) dB, and the UAV is located above all the N ISAC base stations. Assuming that in each trial, 0 to 2 groups of estimated coordinates randomly fail, and 10,000 group of N×5-dimensional vector inputs are generated through simulation.

A better training result can be achieved by reasonably utilizing practical experience and a physical law. Therefore, the present disclosure constructs the two-stage cascaded neural network architecture as shown in FIG. 2. 8,000 groups of data generated through simulation are input into a training process. In the training process, a portion of the data is randomly discarded to prevent overfitting, and 2,000 groups of data are used for verification.

A training effect is determined based on a root mean square error

$$RMSE = \sqrt{1 / N \times {\sum }_{N} [ {( x - \hat{x} )}^{2} + {( y - \hat{y} )}^{2} + {( z - \hat{z} )}^{2} ]}$$

for localization verification. The parameters of each network layer are adjusted based on the magnitude of the mean square error for coordinate verification to obtain the optimal model.

This architecture innovatively decouples hard filtering from soft weighting, enabling millisecond-level real-time inference on a general device and supporting scalability for different quantities of base stations. A model actually deployed on a network is small, meeting a lightweight requirement in practical applications, and can be applied on a large number of embedded edge devices. Moreover, because of its simple structure, this architecture can flexibly adjust a hierarchy in different environments, exhibiting good adaptability.

1. A lightweight intelligent localization method for multi-base-station integrated sensing and communications (ISAC), wherein an ISAC localization system is defined to comprise an unmanned aerial vehicle (UAV) and N ISAC base stations, each of the N ISAC base stations independently transmits a signal based on an orthogonal frequency division multiplexing (OFDM) waveform as an ISAC signal, and receives a corresponding echo signal from the UAV, and positions of the N ISAC base stations are known; and the lightweight intelligent localization method comprises:
S1, estimating a pitch angle and an azimuth angle of the UAV based on echo signals received by the N ISAC base stations from the UAV, and obtaining coordinates of the UAV, specifically:
defining an expression of a μ^{th} symbol on an m^{th} subcarrier of an echo signal received by an n^{th} ISAC base station from the UAV as follows:
$${C}_{n} ( m , μ ) = {U}_{n} {e}^{- j 4 π m Δ {fR}_{n} / c} + η ( m , μ )$$
wherein Rₙ represents a distance of the UAV in a direction of the n^{th} ISAC base station, Uₙ represents an amplitude attenuation, Δf represents a subcarrier spacing, c represents a speed of light, η represents noise, and noise follows a Gaussian distribution with a mean of 0 and a variance of σ², and (m, μ) represents the μ^{th} symbol on the m^{th} subcarrier;
setting that each of the N ISAC base stations is equipped with an X-Y axis L-shaped antenna array with an antenna spacing being half a wavelength and a quantity of antennas on each axis being M, defining θₙ and φₙ to respectively represent an included angle between a signal incidence direction of the UAV and an X-axis of the n^{th} ISAC base station and an included angle between the signal incidence direction of the UAV and a Z-axis of the n^{th} ISAC base station, and dividing antennas on the X-axis of the n^{th} ISAC base station into two parallel subarrays, wherein a first subarray X₁ contains the 1^{st} to the M-1th antennas, and a second subarray X₂ contains the 2^{nd} to the M^{th} antennas; and a steering vector of the X-axis of the n^{th} ISAC base station is as follows:
$${a}_{x . n} = {[ 1 , {e}^{- j π cos {θ}_{n} sin {φ}_{n}} , … , {e}^{- j π ( {M}_{x} - 2 ) cos {θ}_{n} sin {φ}_{n}} ]}^{T}$$
respectively representing echo signals received by the X₁ and the X₂ as follows:
$${R}_{x 1 , r , n} = {a}_{x , n} {s}_{r , n} + {N}_{x 1 , r , n}$$
$${R}_{x 2 , r , n} = {a}_{x , n} {Φ}_{x , n} {s}_{r , n} + {N}_{x 2 , r , n}$$
wherein Φ_{x,n}=exp(−πcos θₙ sin φₙ), s_{r,n} represents an r^{th} row of a received signal Cₙ, and N_{x1,r,n}, and N_{x2,r,n}, respectively represent additive white Gaussian noise on the subarrays X₁ and X₂;
obtaining the Φ_{x,n} by using a least squares subspace rotational invariance algorithm based on the R_{x1,r,n} and the R_{x2,r,n};
similarly, extracting Φ=exp(−π sin θn sin φₙ) from a signal received by a Y-axis antenna;
combining the Φ_{x,n} and the Φ_{y,n}, and obtaining an estimated azimuth angle \tilde{θ}ₙ and an estimated pitch angle \tilde{φ}ₙ;
wherein a steering vector of the n^{th} ISAC base station in a distance dimension is as follows:
$${a}_{d , n} = {( \begin{matrix}1 & {e}^{- j 2 πΔ f \frac{2 {R}_{n}}{c}} & ⋯ & {e}^{- j 2 π ( {N}_{c} - 1 ) Δ f \frac{2 {R}_{n}}{c}}\end{matrix} )}^{T}$$
wherein d represents the distance dimension, and N_{c} represents a quantity of subcarriers of a signal;
respectively representing echo signals of the X₁ and the X₂ in the distance dimension as follows:
$${R}_{x 1 , d , r , n} = {a}_{d , n} {s}_{r , n} + {N}_{x 1 , d , r , n}$$
$${R}_{x 2 , d , r , n} = {a}_{d , n} {Φ}_{d , n} {s}_{r , n} + {N}_{x 2 , d , r , n}$$
wherein Φ_{d,n}=exp(−π2πΔf2Rₙ/c), and N_{x1,d,r,n} and N_{x2,r,n}, respectively represent additive white Gaussian noise of the subarrays X₁ and X₂ in the distance dimension;
substituting the R_{x1,d,r,n} and the R_{x2,d,r,n} into the least squares subspace rotational invariance algorithm, obtaining Φ_{x,n}, and further calculating an estimated distance \tilde{R}ₙ of the UAV relative to each of the N ISAC base stations based on the Φ_{x,n}; and
estimating relative coordinates of the UAV based on the parameters \tilde{θ}ₙ, φₙ, and \tilde{R}ₙ, wherein because an absolute position of each of the N ISAC base stations is known, each of the N ISAC base stations calculates a group of absolute coordinates of the UAV, which is denoted as (\tilde{x}ₙ, \tilde{y}ₙ, \tilde{z}ₙ); and estimating a signal-to-noise ratio (SNR) SNRₙ of a channel between each of the NISAC base stations and the UAV;
S2, generating training data by using a method in the S1, specifically: randomly generating an intermediate obstacle between the UAV and each of the N ISAC base stations, combining parameters generated by each of the N ISAC base stations according to the method in the S1 to form a vector (\tilde{x}ₙ, \tilde{y}ₙ, \tilde{z}ₙ, \tilde{R}ₙ, SNRₙ), synthesizing vectors of the N ISAC base stations into an N×5-dimensional vector as an input of a neural network, recording real coordinates that are of the UAV and correspond to each group of vectors as a label, and generating a plurality of groups of input vectors of the neural network to constitute the training data;
S3, constructing an integrated localization network, wherein the integrated localization network comprises a data input module, a base station group screening module, an intra-group fine-grained weighting module, and a coordinate output module; and a data processing process of the integrated localization network is as follows: after the data input module standardizes coordinate components (\tilde{x}ₙ, \tilde{y}ₙ, \tilde{z}ₙ) of the input N×5-dimensional vector by using a normal distribution and normalizes the estimated distance Ry through logarithmic transformation, converting a parameter vector of the n^{th} ISAC base station into
$${v}_{n} = ( {\tilde{x}}_{n}^{′} , {\tilde{y}}_{n}^{′} , {\tilde{z}}_{n}^{′} , {\tilde{R}}_{n}^{′} , {SNR}_{n} ) ;$$
inputting normalized data into the base station group screening module, wherein in the base station group screening module, a first fully connected layer obtains a feature projection hₙ=ReLU(W₁vₙ+b₁) by using a rectified linear unit (ReLU) activation function, wherein L represents a dimension of a fully connected layer, W₁ represents an L₁×5-dimensional weight matrix, and b₁ represents an L₁-dimensional bias vector; a second connected layer performs quality scoring to obtain a score sₙ=W₂vₙ+b₂ ∈□ corresponding to the n^{th} ISAC base station, wherein W₂ represents a 1×L₁-dimensional weight matrix, and b₂ represents a one-dimensional bias vector; and then adaptively selecting a threshold, comparing a gradient of the sₙ with the threshold by using a straight-through estimator (STE), dynamically generating a 0/1 binary mask, and assigning 0 to an ISAC base station whose sₙ is less than the threshold to eliminate an obviously abnormal ISAC base station, so as to initially select a base station group formed by N′ normal ISAC base stations; and
performing, by the intra-group fine-grained weighting module, physically-guided fine-grained integration on the selected base station group, wherein since a localization error of each of the N ISAC base stations is positively correlated with the estimated distance and negatively correlated with the SNRₙ a coding layer that combines coordinate coding and physical coding is adopted, wherein a coordinate coding layer extracts a spatial feature
$${c}_{n} = {W}_{4} ( ReLU ( {W}_{3} ( {\tilde{x}}_{n}^{′} , {\tilde{y}}_{n}^{′} , {\tilde{z}}_{n}^{′} ) + {b}_{3} ) ) of coordinates ( {\tilde{x}}_{n}^{′} , {\tilde{y}}_{n}^{′} , {\tilde{z}}_{n}^{′} ) ,$$
wherein W₃ represents an L₃×3-dimensional weight matrix, W₄ represents an L₄×L₃-dimensional weight matrix, and b₃ represents an L₃-dimensional bias vector; and a physical coding layer extracts a physical quantity feature
$${p}_{n} = ( {\tilde{R}}_{n}^{′} , {SNR}_{n} ) ;$$
concatenating the features of the two coding layers to obtain a joint feature ƒₙ=[cₙ; pₙ], inputting the ƒₙ into an attention generation layer to obtain a base weight αₙ, introducing a learnable exponential correction term SNR^{β}^{₁}/R^{β}^{₂} to strengthen a physical law constraint, and obtaining a final weight αₙ′ of the n^{th} ISAC base station after performing normalization processing on a mask constraint; and obtaining integrated localization coordinates
$$( \hat{x} , \hat{y} , \hat{z} ) = {\sum }_{n = 1}^{{N}^{′}} {α}_{n}^{′} ( {\tilde{x}}_{n}^{′} , {\tilde{y}}_{n}^{′} , {\tilde{z}}_{n}^{′} )$$
based on the weight
$${α}_{n}^{′}$$
and estimated values (\tilde{x}ₙ, \tilde{y}ₙ, \tilde{z}ₙ) of each of the ISAC base stations; and
S4, training, based on the training data obtained in the S2, the integrated localization network constructed in the S3, and obtaining a trained integrated localization network; and
S5, inputting a group of newly obtained data (\tilde{x}ₙ, \tilde{y}ₙ, \tilde{z}ₙ, \tilde{R}ₙ, SNRₙ) into the trained integrated localization network, and obtaining a localization result.
